(19) United States
(12) Patent Application Publication
(10) Pub. No.: US 2026/0249600 A1
(43) Pub. Date: Aug. 27, 2026

(54) LAYERED STRUCTURE

(71) Applicant: CAMM SOLUTIONS (SPAIN) R&D, S.L.U., Rafelbunyol (Valencia) (ES)

(72) Inventors: Werner BALKAU, Glarus-Süd / Schwändi (CH); Kurt KRONAWITTLEITHNER, Horgen (CH); Robert STEIN, Bad Bramstedt (DE); Bernd LÜHMANN, Norderstedt (DE); Ben DÖHMEN, Hamburg (DE); Sabrina STIEGLER, Aurachtal (DE); Marius-Konstantin WICHE, Hamburg (DE); Kristina KÖLLING, Hamburg (DE)

(21) Appl. No.: 18/861,624

(22) PCT Filed: May 4, 2023
(86) PCT No.: PCT/EP2023/061820

§ 371 Date: Oct. 30, 2024

(30) Foreign Application Priority Data
May 4, 2022 (EP) 22171641.8

(51) Int. Cl. B32B 29/00; B32B 27/10; B32B 37/12

(52) U.S. Cl. CPC B32B 29/002; B32B 27/10; B32B 37/12; B32B 2250/02; B32B 2255/10; B32B 2255/28; B32B 2307/7163; B32B 2307/7244; B32B 2307/7246; B32B 2307/7376; B32B 2310/14; B32B 2329/04; B32B 2439/70

(57) ABSTRACT

A paper base layer and a barrier layer is provided. The barrier layer includes a water-soluble polymer and a salt. The layered structure can be produced by applying the barrier layer as a foil like element onto the paper base layer.

### CROSS-REFERENCE TO RELATED APPLICATIONS

This application claims priority to PCT Application No. PCT/EP2023/061820, having a filing date of May 4, 2023, based on EP Application No. 22171641.8, having a filing date of May 4, 2022, the entire contents both of which are hereby incorporated by reference.

### FIELD OF TECHNOLOGY

The following relates to the field of layered structures. It relates to a layered structure and a method for producing a layered structure.

### BACKGROUND

The present and existing packaging materials suitable for sensitive food products like coffee, cereals, cheese, meat, or chocolate typically consist of multilayer films or multilayer architectures like e.g., PET/Alu/PE or Paper/PET/Alu/PE.

Paper packaging, for example paper boxes are known. Nevertheless, the paper packaging often cannot be recycled through a conventional paper recycle cycle.

Several approaches for coated paper are known, as e.g., WO2019/042694, US 2019/177920, WO2006042364, US 2022/112663, WO 2021/090192 discloses a method where the water-soluble polymer and a crosslinker are cured on the surface of a cellulosic substrate with MFC (microfibrillated cellulose). CN 113 201 160 discloses a porous base layer with an uneven surface coating.

### SUMMARY

An aspect relates to an alternative layered structure and a method for producing a layered structure.

The layered structure comprises a paper base layer and a barrier layer. The barrier layer can be a coating. The barrier layer can be applied on the surface of the paper base layer. In other words: the layered structure is a system with at least two layers, namely the paper base as a first layer and the barrier layer as a second layer. The first and second layer can have essentially the same areal size. The layered structure can be regarded as laminate of the layers and build a layering.

The barrier layer comprises a water-soluble polymer and a salt. The barrier layer may contain further additives.

The salt can be essentially present as solid material. The solid salt can be embedded in the water-soluble polymer of the first layer. The salt can be incorporated into the first layer. The salt may also be partly or fully soluble in the polymer, which may contain further additives.

In embodiments, the barrier layer is designed as a film. The film is a solid-state body and can be applied onto the paper base layer. The barrier layer and the paper base layer can build a laminated layered structure. The barrier layer can be a coextruded cast film.

In embodiments, the barrier layer is free of a synthetic surface sizing agent. A synthetic surface sizing agent can be for example styrene acrylic emulsions (SAE), ScripSet™ styrene maleic anhydride (SMA), or alkyl ketene dimer (AKD) and is disclosed e.g., in US 2019/177920.

In embodiments, water-soluble polymer is cold soluble, meaning that the water-soluble polymer is soluble in cold water. The water-soluble polymer can be soluble in water at a maximum temperature of 40° C., in particular of 38° C. to the most, in particular of 35° C. to the most, in particular of 30° C. to the most. Such a solubility in water enables an integration of the barrier layer e.g., in a paper recycling cycle, in particular in paper recycling according to DIN EN 13430 (as of the end of 2021).

The paper base layer can be paper, fibre substrate or paperboard.

Paper may especially be a non-woven material, pulp-based material. A pulp-based material is a material made from pulp, i.e., from fibers suspended in a liquid (especially water), which is removed at least partially for the production. The fibers may include vegetable fibers (especially fibers of cellulose (wood-based or from fiber crops)), especially at least 50% or at least 80% vegetable fibers or 100% vegetable fibers. In addition, or as an alternative, the fibers may include mineral fibers or other natural fibers, or man-made fibers, for example on a calcium carbonate basis.

The water-soluble polymer can comprise a polymer that has a plurality of vinyl alcohol [CH2CH(OH)] groups in the polymer chain, in particular wherein the water-soluble polymer is poly(vinyl alcohol) (PVOH).

The water-soluble polymer can be at least one of:
poly(vinyl alcohol) (PVOH),
cellulose-ether polymer,
Butenediol-Vinylalcohol-Copolymer (BVOH), and
Ethylene-Vinylalcohol-Copolymers (EVOH).

The water-soluble polymer can comprise at least one vinyl-alcohol copolymer and/or a mixture and/or blend of two or more vinyl-alcohol copolymers. The copolymers can differ in molar mass, molecular architecture, e. g. branching, comonomer type and amount, to name only a few variation parameters.

The water-soluble polymer can comprise further polar comonomers. Examples include maleic acid and maleic acid anhydride, fumaric acid and itaconic acid.

The PVOH can be a vinyl alcohol rich copolymer and/or vinyl alcohol homopolymer.

The water-soluble polymer, in particular the polyvinyl alcohol (PVOH), can have a degree of hydrolysis of 70% to 99.9%. The degree of saponification can control the performance to the oxygen transmission barrier. A higher saponification may for instance improve the oxygen transmission barrier performance.

A vinyl-alcohol containing polymer can comprise >75%, in particular >90%, monomer units carrying an OH unit.

The barrier layer can comprise at least one of the following polymers:
Poly(vinyl alcohol) obtained e.g., by the saponification of Poly(vinyl ester) homopolymers or copolymers,
Ethylene-Vinylalcohol-Copolymers (EVOH),
Butenediol-Vinylalcohol-Copolymer (BVOH), to name only a few.

In an embodiment, at least one of the barrier layers and the layered structure is at least one of bio-degradable and compostable, in particular home compostable. This means the barrier layer can be bio-degradable and/or compostable. It also means that the layered structure as a whole can be bio-degradable and/or compostable.

In the present text, “bio-degradable” may mean biologically degradable according to the European standard EN 13432 (as of the end of 2021). In addition, or as an alternative, it may mean biologically degradable according to the European standard EN 14995 (as of the end of 2021). Thus “bio-degradable” especially refers to “biologically degradable according to EN 13432 and/or according to EN 14995.

In the present text, “compostable” or “home compostable” means compostable or home compostable according to the European standard EN13432 (as of the end of 2021) for packaging and/or according to the European standard EN14995 (as of the end of 2021) for plastics/synthetic materials.

In an embodiment, the barrier layer and/or the layered structure can be bio-degradable in at least one of soil, water, waste water.

The bio-degradability in waste water in this text means being bio-degradable in waste water according to EN ISO 9888 (as of the end of 2021), in particular according to Zahn-Wellens-Test, in particular at 20° C.

In other words: As far as in the present text water-soluble polymers are mentioned, such water-soluble polymer may optionally be (bio-)degradable in sewage treatment plants (aerobic biodegradability) in accordance with EN ISO 9888 (as of the end of 2021); determined in accordance with the so-called Zahn-Wellens test, in particular at 20° C.

Bio-degradation in the context of this text means the breakdown of the polymers of the barrier layer by microorganisms. Bio-degradability means that a material must have degraded to more than 90 percent to water, carbon dioxide (CO2) and biomass after a specified time under defined specific temperature, oxygen and humidity conditions in the presence of microorganisms or fungi.

The term compostable refers to a bio-degradation under specific conditions.

In order for the barrier layer, in particular the first layer and/or the second layer, to be compostable, at least the following conditions must be fulfilled:
at least 90% of the organic material must be verifiably bio-degraded in CO2 within 6 months;
after 3 months of composting and subsequent screening through a 2 mm mesh sieve, no more than 10% residue of the original mass may remain;
there must be no negative effects on the composting process in general;
no negative effect of the resulting composts on plant growth (agronomic test) and/or ecotoxicity test
the maximum concentration of heavy metals (Cu, Zn, Ni, Cd, Pb, Hg, Cr, Mo, Se, As) and florins must not be exceeded.

In order for the barrier layer, in particular the first layer and/or the second layer, to be home compostable, at least the following conditions can be fulfilled:
at least 90% of the material must have decomposed into water, carbon dioxide and biomass in a compost heap (at approx. 30° C.) within 6 months;
neither organic pollutants nor heavy metals may enter the soil;
the substances must not have any negative impact on the compost quality;
the products can be disposed of in the garden compost and in the organic waste bin.

During composting barrier layer and/or the layered structure can be decomposed. barrier layer and/or the layered structure can be composed and/or decomposed in a short time to carbon dioxide (CO2) and water (H2O) and biomass.

The barrier layer and/or the layered structure can be industrial and/or home compostable. The home compostability may not negatively influence the industrial composting process.

In addition, the salt has been found to also improve solubility, disintegration, and bio-degradation speed, for example for composting. The addition of the salt can render a polymer home-compostable, if without the salt it would be capable of being composted industrially only but not per se home-compostable. The salt content, therefore, may be used to tune the properties of the polymer composition depending on the intended use and intended recycling process.

While water-soluble polymers may be bio-degradable, this is not necessarily the case for all water-soluble polymers. The water-soluble polymer of the layered structure may be bio-degradable in addition to being water-soluble.

In embodiments, all components of the layered structure are of bio-degradable materials.

In embodiments, the layered structure comprises a bio-degradable lamination glue.

The glue improves the adhesion between the paper base layer and the barrier layer.

The glue can be at least one of a water based Epotal ECO, polyester-polyurethane lamination adhesive for paper-plastic laminates.

In embodiments, the layered structure is recyclable in a paper recycling process, in particular in paper recycling process according to DIN EN 13430 (as of the end of 2021). DIN being a European standard.

The layered structure suits the demand of the paper recycling process. This means the layered structure can be disposed in the paper waste bin.

In embodiments, the barrier layer is arranged on one flat side of the paper base layer.

The paper base layer comprises two flat sides, like a piece of paper. In embodiments, the surface of at least one flat side of the paper base layer is arranged adjacent to the barrier layer. In embodiments, one flat side of the paper base layer is free of a barrier layer.

In embodiments, the surface of both flat sides of the paper base layer are arranged adjacent to a barrier layer.

In embodiments, the lamination glue is arranged between the paper base layer and the barrier layer.

In embodiments, the barrier layer can comprise an additional coating. The coating can be arranged between the paper base layer and the barrier layer and/or on the barrier layer facing away from the paper base layer.

The coating can be at least one of a plasma coating, an acryl coating, a wax coating, an Ormocer coating.

In embodiments, the barrier layer comprises at least a first sub-layer and a second sub-layer. The first sub-layer comprises the water-soluble polymer as well as the salt and is configured to act as an oxygen barrier.

The second sub-layer is configured to act as a water vapor and/or humidity barrier.

In embodiments, the layered structure, in particular the barrier layer, in particular the second sub-layer, can have a water vapor and/or humidity barrier of a maximum of 15 g/m² per day at 23° C. and a relative humidity of 85%, in particular a maximum of 10 g/m² per day at 23° C. and a relative humidity of 85%, in particular 7 g/m² per day at 23° C. and a relative humidity of 85%, in particular a maximum of 1 g/m² per day at 23° C. and a relative humidity of 85%, in particular a maximum of 0.5 g/m² per day at 23° C. and a relative humidity of 85%, in particular a maximum of 0.1 g/m² per day at 23° C. and a relative humidity of 85%.

The water vapor and/or humidity barrier in this text is determined according to ISO 15106-2 (as of April 2022).

The second sub-layer can comprise at least one of the following components:
polyester
aliphatic polyester
poly(hydroxy alkanoates) (PHAs)
polylactic acid (PLA)
poly butylene succinate (PBS)
poly(hydroxy butyrates) (PHB), in particular Poly(3-hydroxy butyrate), as well as
copolymers containing 3-hydroxy butyrate as comonomer.

The second sub-layer can also be water-soluble. The solubility of the second sub-layer in water might be lower than the water solubility of the first sub-layer.

In an embodiment, the sub-layer of the barrier layer can be at least partially separable from each other.

According to the state-of-the-art multiple layers of chemically similar material is irreversible bound to each other. The resulting material can also be called mono-material. Such a mono-material is difficult to impossible to recycle. In contrast to that the sub-layer of the present barrier layer can be separated from each other and can be recycled individual.

In embodiments, the sub-layer of the barrier can be separated from each other under the conditions of the recycling process. In embodiments the sub-layers are separable at a maximum temperature of 40° C., in particular of 38° C. to the most, in particular of 35° C. to the most, in particular of 30° C. to the most, in an aqueous environment.

In embodiments, the first sub-layer can be arranged facing the paper base layer and the second sub-layer faces away from the flat side of the paper base layer.

In embodiments, the second sub-layer can be arranged facing the paper base layer and the first sub-layer faces away from the flat side of the paper base layer.

In embodiments, the layered structure is a high barrier paper. The high barrier paper can provide a water vapor and/or humidity barrier.

In embodiments, the high barrier paper can have a water vapor and/or humidity barrier of a maximum of 15 g/m² per day at 23° C. and a relative humidity of 85%, in particular a maximum of 10 g/m² per day at 23° C. and a relative humidity of 85%, in particular 7 g/m² per day at 23° C. and a relative humidity of 85%, in particular a maximum of 1 g/m² per day at 23° C. and a relative humidity of 85%, in particular a maximum of 0.5 g/m² per day at 23° C. and a relative humidity of 85%, in particular a maximum of 0.1 g/m² per day at 23° C. and a relative humidity of 85%.

In embodiments, the layered structure provides an adhesion between the paper base layer and the barrier layer with sufficient peel strength. Such an excellent adhesion allows for complex constructions of pouches and packaging as well as for high packing line speed.

The barrier layer is more stable than the paper base layer. The peel strength can be regarded as an inherent property of the paper base layer. When peeling of the barrier layer from the paper base layer the fibres of the paper base layer get pulled out of the paper base layer. The fibres break and are at least partly get ripped out. This underlines a good adhesion of the barrier layer on the paper base layer.

In embodiments, the paper base layer has a thickness of 40 μm to 150 μm, in particular of 50 μm to 130 μm, in particular of 60 μm to 120 μm. The paper base layer can have a maximum thickness of 67 μm, in particular of 50 μm. The thickness of the paper base layer can be 114 μm at 80 gsm grammage.

In embodiments, the paper base layer comprises a grammage of about 40 to 100 gsm. The grammage of the paper base layer can range from 45 gsm to 80 gsm. Gsm meaning grams per square metre, also known as g/m².

The paper base layer may be coated to further improve the barrier properties of the layered structure.

For example, organic-inorganic hybrid coatings might be used, like Ormocer coatings as developed by the Fraunhofer ISC in Würzburg, or related coatings offered by Nanopool GmbH, Switzerland may be used. Due to their high cross-link density and partial inorganic nature such coatings may enhance barrier properties even if applied as very thin layers.

In embodiments, plasma coatings may also be applied to the paper base layer and/or the barrier layer. For certain applications (especially products with very high barrier requirements), the barrier properties of the existing composite may need to be further enhanced. For this purpose, it is possible to apply an additional plasma coating to the material. The coating may be applied via a roll-to-roll process inside a vacuum chamber (see S. Günther “Der Prozess der plasmaunterstützten Aluminiumbedampfung und die Eigenschaften dadurch hergestellter Schichten”). However, plasma treatment may also be performed under normal pressure. The coated films exhibit both good barrier properties and are suitable for use on processing machines. Plasma coatings may be applied in combination with organic-inorganic hybrid coatings to suit further improved barrier performance.

The thickness, grammage and tensile strength of the paper are the main factors by which the mechanical properties, such as stiffness of the packaging, such as a bag or pouch, can be determined.

In embodiments, at least one of the following conditions is, in particular all of the following conditions are, fulfilled:
the layered structure has an overall thickness of approximately 130 μm;
the processability of the layered structure on the laminating/extrusion/coating line is guaranteed;
the processability on the packaging machine must be ensured.

In embodiments, the layered structure offers easy manufacturing of vinyl alcohol rich copolymer formulations without deterioration of the same. The deterioration can be prevented by adjustment of the processing temperature, in particular towards lower temperature.

In embodiments, the layered structure offers high barrier-performance with respect to oxygen permeation and permeation of water/humidity.

In embodiments, the layered structure is recyclable and may even increase the quality of the output of the recycling streams.

The barrier layer can have a thickness of 30 to 300 micrometer, in particular at least 30 micrometer or at least 50 or even at least 100 micrometer. The maximum thickness of the barrier layer can be 100 micrometer or 120 micrometer or 150 micrometer or 200 micrometer or 300 micrometer to the most.

The first sub-layer can have a thickness of 2 micrometer to 200 micrometer. The first sub-layer can have a thickness of at least 2 micrometer or at least 3 micrometer or at least 5 micrometer or at least 10 micrometer or at least 20 micrometer. The maximum thickness of the first sub-layer can be 20 micrometer or 40 micrometer or 50 micrometer or 70 micrometer or 100 micrometer or 200 micrometer to the most.

The second sub-layer can have a thickness of 2 micrometer to 200 micrometer. The second sub-layer can have a thickness of at least 2 micrometer or at least 3 micrometer or at least 5 micrometer or at least 10 micrometer or at least 20 micrometer. The maximum thickness of the first sub-layer can be 20 micrometer or 40 micrometer or 50 micrometer or 70 micrometer or 100 micrometer, or 200 micrometer to the most.

In embodiments, the barrier layer is an oxygen barrier.

In embodiments, the layered structure, in particular the barrier layer, can have an oxygen transmission rate (OTR) of a maximum of 3 cm³/m² per day at room temperature (RT, room temperature=23° C.) and a relative humidity of 50% (rel. H), in particular the oxygen transmission rate can be maximal 1 cm³/m² per day at 23° C. and a relative humidity of 50%, in particular maximal 0.2 cm³/m² per day at room temperature (23° C.) and a relative humidity of 50%, in particular maximal 0.05 cm³/m² per day at room temperature (23° C.) and a relative humidity of 50%.

The oxygen transmission rate (OTR) is the steady state rate at which oxygen gas permeates through a film at specified conditions of temperature and relative humidity. Values are expressed in cc/m2/24 hr in metric (or SI) units, with cc being cubic centimetre being cm³, m2 being square metre, 24 hr being 24 hours being one day. The OTR in this text is determined according to ISO 15105-2 (as of April 2022). The test gas is oxygen, the carrier gas is nitrogen, water is added to the test gas to realize the 50 % rel. H at 23° C. A sample of the layered structure is cut with a diameter of lid 105 mm to fit the test area diameter of 80 mm. The sample is mounted on a lid and clamped into the measurement apparatus. Water vapour in nitrogen or oxygen is fed to the sample via the lid, The measuring sensor is located on the opposite side of the sample. The sample is mounted between test chambers at ambient atmospheric pressure. One chamber contains oxygen, and the other chamber is slowly purged by a stream of nitrogen. Due to the concentration difference between the two chambers, oxygen molecules permeate through the sample into the nitrogen side and are taken to the sensor where it produces corresponding electrical signals. The oxygen transmission rate is then obtained by analysing and calculating the signals.

In embodiments, the salt of the barrier layer comprises a salt of at least one of alkalimetals, earth alkali metals, aluminum containing salt and/or a mixture thereof, in particular NaCl, Na-citrate, and the respective potassium analogues.

In embodiments, the salt of the barrier layer comprises at least 1 wt. %, in particular at least 2 wt. %, of the salt.

In embodiments, the salt of the barrier layer comprises 1-40 wt %, in particular 2-30 wt %, of the salt.

The salt may be present in an amount of at least 1% or at least 2% or at least 3% or at least 10% or at least 15% or even at least 20% or at least 25% with a maximum amount being 55% or 40% or 35% salt. In the present text, all percentages refer to % by weight unless specified otherwise.

The salt content of the barrier layer can also be specified in Vol %. The unit Vol % can be recalculated from the wt % using the density of the salt and the components of the first layer.

The barrier layer can comprise salt with least 1 Vol % or at least 2 Vol % or at least 3 Vol % or at least 10 Vol % or at least 15 Vol % or even at least 20 Vol % or at least 25 Vol % with a maximum amount being 55 Vol % or 40 Vol % or 35 Vol %.

In embodiments, the barrier layer comprises a vinyl-alcohol copolymer comprising 1 to 25 mol % of comonomer not being vinyl alcohol.

In embodiments, the barrier layer comprises an inorganic filler.

In embodiments, platelet like nanoscale fillers which at least partially distribute in form of their primary particles may be added. Due to increasing the effective path diffusing molecules like oxygen and water need to migrate through the volume of the barrier layer, its barrier performance will be enhanced respectively. Nanoclay presents one example of a possible filler providing what is also known as tortuous path for diffusing molecules.

In embodiments, the inorganic filler can be in particular a clay mineral, in particular bentonite, montmorillonite, to name only a few.

In embodiments, the inorganic filler can be in particular single metal or mixed metal carbonate, in particular calcium carbonate including precipitated calcium carbonate.

In embodiments, the inorganic filler can be in particular silica, in particular fumed silica.

In embodiments, the barrier layer comprises an organic filler. The organic filler can be at least one of:
cellulose, cellulose derivatives like cellulose esters, cellulose ethers, lignocellulose and/or a mixture thereof, in particular low molar mass oligomers of the same;
starch and starch derivatives, in particular low molar mass oligomers of the same;
Chitin, Chitosan and derivatives thereof;
coffee silverskin.

In embodiments, the barrier layer comprises a minimum of 35 wt % of one or more respective vinyl alcohol rich copolymers.

In embodiments the barrier layer has a maximum water content of 10%, for example a water content of not more than 5%, especially of not more than 1% or not more than 0.5%.

In embodiments, the barrier layer comprises a plasticizer. The plasticizer may be selected from the group consisting of polyols (oligo- and polyhydroxy compounds), low molecular weight amides, in particular of triols, diols, polymeric-triols, polymeric-diols, for example glycerine, ethylene glycol, propylene glycol, triethylene glycol, low molecular weight polyethylene glycols; and lower molecular weight amides.

In embodiments, the plasticizer may be selected from the group consisting of di-propylene glycol, higher oligomers of ethylene glycol or propylene glycol, butylene glycol, glycerol, pentaerythritol, sorbitol, 1,4-Monoanhydrohexitols, 1,4-3,6-dianhydrohexitols as well as esters of the same. Desirable plasticizers are glycerine, and polypropylene glycol. Glycerine or another plasticizer may be present in an amount of between 2% and 25%, especially between 5% and 18%.

Examples of suitable composition of the barrier layer for example be found in WO 2014/155059.

In embodiments, the barrier layer is essentially evenly distributed on the paper base layer. In other words: the barrier layer can be a uniform layer without holes. The barrier layer can cover essentially one flat side of the paper base layer. The barrier layer can be a continuous layer.

In embodiment, the barrier layer does not comprise any starch.

A method for producing a layered structure, in particular a layered structure as described in this application, comprises the steps of:
providing a paper base layer; and
applying a barrier layer on the paper base layer.

In embodiments, the barrier layer is applied to the paper base layer as a foil like element. Accordingly, the barrier layer can be applied on the paper base layer at low temperature. The barrier layer is in solid state when applied to the paper base layer. This differs from an impregnation of the paper base layer with the components of the barrier layer at least by the application temperature. This enables to work at lower temperatures and can reduce the risk of deterioration of the layered structure.

In embodiments, the applied barrier layer comprises a first sub-layer and a second sub-layer.

Use of a layered structure as described in this application for packaging, in particular for food packaging, in particular for packaging coffee.

Packaging comprising a layered structure as described in this application.

In embodiments, the side of the paper base layer being adjacent to the barrier layer is oriented towards the inner volume of the packaging. This allows the consumer to have haptic paper feedback on the outside of the packaging. Nevertheless, inside of the packaging provides barrier properties related to the barrier layer.

### BRIEF DESCRIPTION

Some of the embodiments will be described in detail, with references to the following Figures, wherein like designations denote like members, wherein:

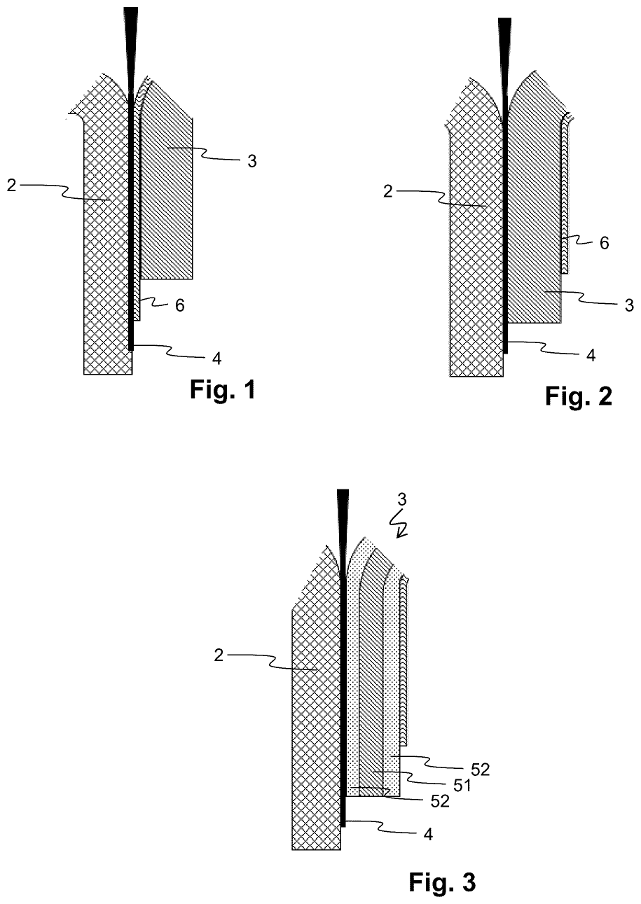

FIG. 1 shows a layered structure 1 with a paper base layer and a barrier layer;

FIG. 2 shows a layered structure with a coating facing away from the paper base layer,

FIG. 3 shows a layered structure 1 with a multi-layered barrier layer 3 and a coating;

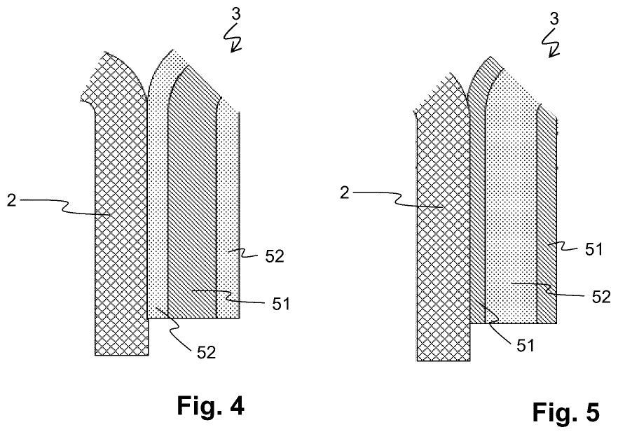

FIG. 4 shows a layered structure 1 with a multi-layered barrier layer 3; and

FIG. 5 shows a layered structure 1 with another multi-layered barrier layer 3.

### DETAILED DESCRIPTION

FIG. 1 shows a layered structure 1 with a paper base layer 2 and a barrier layer 3. The barrier layer 3 comprises a water-soluble polymer and a salt. The barrier layer 3 is configured to act as an oxygen transmission barrier.

The salt is essentially present as solid material. The solid salt can be embedded in the water-soluble polymer of the barrier layer 3.

The paper base layer 2 is a paper sheet.

The barrier layer 3 is arranged on one flat side of the paper base layer 2. The barrier layer 3 comprises an additional coating 6. The barrier layer 3 is adhered to the paper base layer 2 with a glue 4. The coating 6 is facing towards the paper base layer 2 being arranged next to the glue 4.

The paper base layer 2 has a thickness of 50-82 micrometre. The barrier layer 3 has a thickness of 50-70 micrometre. The coating 6 has a thickness of barrier layer 3-5 micrometre. The glue 4 has a thickness of layered structure 1-5 micrometre.

FIG. 2 shows a similar embodiment as FIG. 1, but the coating 6 is facing away from the paper base layer 2 and does not contact the glue 4.

In FIG. 3 the barrier layer 3 is multi-layered comprising a first sub-layer 51 and a second sub-layer 52. The first sub-layer 51 comprises the water-soluble polymer and the salt. The first sub-layer 51 is configured to act as an oxygen transmission barrier. The second sub-layer 52 is configured to act as a water vapor and/or humidity barrier.

The first sub-layer 51 being covered in both sides by the second sub-layer 52.

As in FIG. 2, a coating 6 is applied to the multi-layered barrier layer 3. The coating 6 faces away from the paper base layer 2.

The multi-layered barrier layer 3 has a thickness of 70 micrometre, with the thickness of the first sub-layers 51 being 50 micrometre and each of the second sub-layers 52 is 10 micrometres thick.

FIG. 4 and FIG. 5 show a layered structure 1 with a paper base layer 2 and a barrier layer 3 is a multi-layered barrier layer 3 being a coextruded cast film. The multi-layered barrier layer 3 comprises three layered, wherein the two outer layers are essential identical and cover a middle layer being different from the outer layer.

The outer layers are 20 micrometres thick, and the middle layer has a thickness of 40 micrometre.

The multi-layered barrier layer 3 is applied to the paper base layer 2.

In FIG. 4 the out layers are the second sub-layer 52, with a water vapor and/or humidity barrier, and the middle layer is the first sub-layer 51, with the oxygen transmission barrier. The second sub-layer 52 is directed towards the paper base layer 2. The first sub-layer 51 does not contact the paper base layer 2.

In FIG. 5 the out layers correspond to the first sub-layer 51, with the oxygen transmission barrier, and the middle layer is the second sub-layer 52, with the vapor and/or humidity barrier. The first sub-layer 51 is directed towards the paper base layer 2. The second sub-layer 52 does not contact the paper base layer 2.

The first sub-layer 51 can have a thickness of 12 to 15 micrometer and the second sub-layer 52 can have a thickness of 25 micrometer.3

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A layered structure comprising:
a paper base layer and
a barrier layer
wherein the barrier layer comprises:
a water-soluble polymer and
a salt
wherein the barrier layer is free of a synthetic surface sizing agent.

2. The layered structure according to claim 1, wherein the layered structure, the barrier layer, comprises an oxygen transmission rate of a maximum of 3 cm³/m² per day at 23° C. and a relative humidity of 50%, the maximal 1 cm³/m² per day at 23° C. and a relative humidity of 50%, maximal 0.2 cm³/m² per day at 23° C. and a relative humidity of 50%.

3. The layered structure according to claim 1, wherein the water-soluble polymer comprises a polymer that has a plurality of vinyl alcohol [CH2CH(OH)] groups in the polymer chain, wherein the water-soluble polymer is poly(vinyl alcohol) (PVOH).

4. The layered structure according to claim 1, wherein at least one of the barrier layer and the layered structure is at least one of bio-degradable and compostable, home compostable;

5. The layered structure according to claim 1, wherein the layered structure is recyclable in a paper recycling process, in paper recycling process according to EN 13430 (as of the end of 2021).

6. The layered structure according to claim 1, wherein the barrier layer is arranged on one flat side of the paper base layer.

7. The layered structure according to claim 1, wherein the barrier layer comprises a first sub-layer and a second sub-layer, wherein the first sub-layer comprises the water-soluble polymer as well as the salt and is configured to act as an oxygen barrier; and
wherein the second sub-layer is configured to act as a water vapor and/or humidity barrier.

8. The layered structure according to claim 1, wherein the layered structure is a high barrier paper.

9. The layered structure according to claim 1, wherein the barrier layer is configured as a film.

10. The layered structure according to claim 1, wherein the paper base layer fulfils at least one of the following conditions:
the paper base layer has one of a thickness of 40 μm to 150 μm, of 50 μm to 130 μm, and of 60 μm to 120 μm;
the paper base layer comprises a grammage of about 40 to 100 gsm.

11. The layered structure according to claim 1, wherein barrier layer fulfils at least one of the following conditions:
the barrier layer is an oxygen barrier;
the salt comprises a salt of at least one of alkali metals, earth alkali metals, aluminum comprising salt and/or a mixture thereof, wherein the salt and/or mixture thereof is NaCl, Na-citrate, and the respective potassium analogues;
the barrier layer comprises one of at least 1 wt. %, or at least 2 wt. %, of the salt;
the barrier layer comprises one of 1-40 wt %, 2-30 wt %, of the salt;

12. A method for producing a layered structure, a layered structure according to claim 1, comprising:
providing a paper base layer;
applying a barrier layer on the paper base layer.

13. The method according to claim 12, wherein the barrier layer is applied to the paper base layer as a foil like element.

14. A method comprising utilizing a layered structure according to claim 1 for packaging coffee.

15. Packaging comprising a layered structure according to claim 1.
